(19) United States
(12) Patent Application Publication
(10) Pub. No.: US 2020/0122520 A1
(43) Pub. Date: Apr. 23, 2020

(54) WINTER TIRE STUD

(71) Applicant: The Goodyear Tire & Rubber Company, Akron, OH (US)

(72) Inventors: Frédéric Michel-Jean PONS, Thionville (FR); Arnaud CARON, Signeulx (BE)

(21) Appl. No.: 16/166,207

(22) Filed: Oct. 22, 2018

(51) Int. Cl. B60C 11/16

(52) U.S. Cl. CPC B60C 11/1668; B60C 11/1675

(57) ABSTRACT

A stud is configured to be inserted into a tread portion of a tire. The stud includes a tip end protruding from the tread portion for contacting a surface, and a base including a flanged bottom portion provided on an end opposite the tip end and extending radially outward, a stump portion provided between the bottom portion and the tip end, and a shank portion interconnecting the stump portion and the bottom portion. The base is embedded and secured in the tread portion of the tire in which the stud is installed. The bottom portion has a tear-drop shape consisting of three planar sides and one semi-cylindrical side. The stump portion has a polygonal shape consisting of three concave sides, two convex sides, and one planar side.

### FIELD OF INVENTION

The present invention relates to stud pins installed in a tread portion of a pneumatic tire and, more particularly, to a pneumatic tire equipped with the stud pins.

### BACKGROUND OF THE INVENTION

Conventional snow tires may be equipped with stud pins installed in the tread portion of the tire to allow the tire to grip an icy or snowy road surface. A stud pin may be embedded into a stud pin installation hole provided in the tread portion of the tire. The stud pin may broaden a pin bore and be tightly embedded therein so that the stud pin does not fall out of the stud pin installation hole due to braking, driving, or lateral and vertical forces received from the road surface while the tire is rotating.

The stud pin may have a pillar and a pin. The pillar may be fitted into a close-ended hole formed in the tread portion of the tire and thereby be secured to the tread surface. The pin may protrude radially outward from the pillar. The pillar may be asymmetrically and/or irregularly shaped as it extends radially outward from the tread portion.

When these studded snow tires are used on concrete or asphalt road surfaces not coved by snow or ice, these harder, bare road surfaces may dislodge the stud pins. Even for tires equipped with the above-mentioned stud pins, there are cases where the stud pins often fall out (pin drop) due to the forces on the tire while a vehicle is driving, breaking, and/or cornering on a concrete or asphalt road. There will be a large amount of pin drop if there is any clawing force applied between the stud pin and the road surface. The clawing force may overcome the force retaining the stud pin in the tread rubber material of the tire. Therefore, there is a demand for further improvement regarding pin drop for these pneumatic stud tires, as well as, the other performance characteristics of the stud pins (e.g., traction, durability, wear, etc.).

### SUMMARY OF THE INVENTION

A stud, in accordance with the present invention, is configured to be inserted into a tread portion of a tire. The stud includes a tip end protruding from the tread portion for contacting a surface, and a base including a flanged bottom portion provided on an end opposite the tip end and extending radially outward, a stump portion provided between the bottom portion and the tip end, and a shank portion interconnecting the stump portion and the bottom portion. The base is embedded and secured in the tread portion of the tire in which the stud is installed. The bottom portion has a tear-drop shape consisting of three planar sides and one semi-cylindrical side. The stump portion has a polygonal shape consisting of three concave sides, two convex sides, and one planar side.

According to another aspect of the stud, the tip end has a hexagonal-like cross-sectional shape extending radially outward from a radially outermost surface of the stump portion of the base.

According to still another aspect of the stud, the tip end has a cross-section with three concave surfaces with three planar surfaces.

According to yet another aspect of the stud, the cross-section of the stump portion includes a flat side circumferentially disposed between first and second concave hollows and two convex sides circumferentially separated by a third concave hollow.

According to still another aspect of the stud, the cross-section of the stump portion includes a flat side circumferentially disposed between first and second concave hollows and first and second convex sides circumferentially separated by a third concave hollow. The first concave hollow is adjacent the first convex side and the second concave hollow is adjacent the second convex side.

According to yet another aspect of the stud, the bottom portion has a tear drop cross-section with three planar sides and one semi-cylindrical side.

According to still another aspect of the stud, the shank portion has a thinner cross-section compared to the bottom portion.

According to yet another aspect of the stud, the shank portion has a thinner cross-section compared to the trunk portion.

According to still another aspect of the stud, the shank portion has an oval-shaped cross-section.

According to yet another aspect of the stud, the tip end has a radially outermost surface with four generally planar surfaces converging to form an outer point for improving engagement of the stud with an ice surface.

A first stud configuration for a tire tread in accordance with the present invention includes: a first plurality of studs disposed in a first region of the tire tread, the first plurality of studs each having a first orientation; a second plurality of studs disposed in a second region of the tire tread, the second plurality of studs each having a second orientation rotated +90 degrees relative to a radial axis; and a third plurality of studs disposed in a third region of the tire tread, the third plurality of studs each having a third orientation rotated −90 degrees relative to the radial axis.

According to another aspect of the first stud configuration, the first plurality of studs, the second plurality of studs, and the third plurality of studs each have an identical construction (e.g., all studs are the stud 50 shown in FIG. 1).

According to still another aspect of the first stud configuration, the first region is a shoulder portion of the tread portion, the second region is a center portion of the tread portion, and the third region is another shoulder portion of the tread portion.

According to yet another aspect of the first stud configuration, the first plurality of studs each have a tip end with a first size 181, the second plurality of studs each have a tip end with a second size 182, and the third plurality of studs each have a tip end with the first size 181. The first size 181 is larger than the second size 182 (FIG. 7).

According to still another aspect of the first stud configuration, the first plurality of studs each have a tip end with a first size 182, the second plurality of studs each have a tip end with a second size 181, and the third plurality of studs each have a tip end with the first size 182. The second size 181 is larger than the first size 182 (FIG. 7).

A second stud configuration for a tire tread in accordance with the present invention includes: a first plurality of studs disposed in a first region of the tire tread, the first plurality of studs each having a first orientation; a second plurality of studs disposed in a second region of the tire tread, the second plurality of studs each having a second orientation rotated +45 degrees relative to a radial axis; and a third plurality of studs disposed in a third region of the tire tread, the third plurality of studs each having a third orientation rotated −45 degrees relative to the radial axis.

According to another aspect of the second stud configuration, the first plurality of studs, the second plurality of studs, and the third plurality of studs each have an identical construction (e.g., all studs are the stud 50 shown in FIG. 1).

According to still another aspect of the second stud configuration, the first region is a shoulder portion of the tread portion, the second region is a center portion of the tread portion, and the third region is another shoulder portion of the tread portion.

According to yet another aspect of the second stud configuration, the first plurality of studs each have a tip end with a first size 181, the second plurality of studs each have a tip end with a second size 182, and the third plurality of studs each have a tip end with the first size 181. The first size 181 is larger than the second size 182 (FIG. 7).

According to still another aspect of the second stud configuration, the first plurality of studs each have a tip end with a first size 182, the second plurality of studs each have a tip end with a second size 181, and the third plurality of studs each have a tip end with the first size 182. The second size 181 is larger than the first size 182 (FIG. 7).

### Definitions

The following definitions are controlling for the present invention.

“Axial” and “Axially” means the lines or directions that are parallel to the axis of rotation of the tire.

“Axially Inward” means in an axial direction toward the equatorial plane.

“Axially Outward” means in an axial direction away from the equatorial plane.

“Bead” or “Bead Core” generally means that part of the tire comprising an annular tensile member of radially inner beads that are associated with holding the tire to the rim.

“Belt Structures” or “Reinforcement Belts” or “Belt Package” means at least two annular layers or plies of parallel cords, woven or unwoven, underlying the tread, unanchored to the bead, and having both left and right cord angles in the range from 18 degrees to 30 degrees relative to the equatorial plane of the tire.

“Carcass” means the tire structure apart from the belt structure, tread, undertread over the plies, but including the beads.

“Circumferential” means circular lines or directions extending along the perimeter of the surface of the annular tread perpendicular to the axial direction; it can also refer to the direction of the sets of adjacent circular curves whose radii define the axial curvature of the tread, as viewed in cross section.

“Directional Tread Pattern” means a tread pattern designed for specific direction of rotation.

“Equatorial Plane” means the plane perpendicular to the tire's axis of rotation and passing through the center of its tread; or the plane containing the circumferential centerline of the tread.

“Footprint” means the contact patch or area of contact of the tire tread with a flat surface under normal load pressure and speed conditions.

“Groove” means an elongated void area in a tread that may extend circumferentially or laterally in the tread in a straight, curved or zigzag manner. It is understood that all groove widths are measured perpendicular to the centerline of the groove.

“Hertz” means number of cycles per second.

“Lateral” means a direction going from one sidewall of the tire towards the other sidewall of the tire.

“Net to gross” means the ratio of the net ground contacting tread surface to the gross area of the tread including the ground contacting tread surface and void spaces comprising grooves, notches and sipes.

“Notch” means a void area of limited length that may be used to modify the variation of net to gross void area at the edges of blocks.

“Ply” means a cord-reinforced layer of rubber coated radially deployed or otherwise parallel cords.

“Radial” and “radially” mean directions radially toward or away from the axis of rotation of the tire.

“Radial Ply Tire” means a belted or circumferentially-restricted pneumatic tire in which at least one ply has cords which extend from bead to bead are laid at cord angles between 65 degrees and 90 degrees with respect to the equatorial plane of the tire.

“Shoulder” means the upper portion of sidewall just below the tread edge.

“Sidewall” means that portion of a tire between the tread and the bead.

“Sipe” means a groove having a width in the range of 0.2 percent to 0.8 percent of the tread width. Sipes are typically formed by steel blades having a 0.4 to 1.6 mm, inserted into a cast or machined mold.

“Tangential” and “Tangentially” refer to segments of circular curves that intersect at a point through which can be drawn a single line that is mutually tangential to both circular segments.

“Tread” means the ground contacting portion of a tire.

“Tread width” (TW) means the greatest axial distance across the tread, when measured (using a footprint of a tire,) laterally from shoulder to shoulder edge, when mounted on the design rim and subjected to a specified load and when inflated to a specified inflation pressure for said load.

“Void Space” means areas of the tread surface comprising grooves, notches and sipes.

### BRIEF DESCRIPTION OF THE DRAWINGS

The present invention will be better understood through reference to the following description and the appended drawings, in which:

FIG. 1 schematically represents an external perspective view of a stud in accordance with the present invention.

FIG. 2 schematically represents an external orthographic radial view of the stud of FIG. 1.

FIG. 3 schematically represents a sectional view taken along line “3-3” of part of the stud of FIG. 2.

FIG. 4 schematically represents a sectional view taken along line “4-4” of part of the stud of FIG. 2.

FIG. 5 schematically represents a radial orthographic view of a tread for use with a configuration of the studs of FIG. 1 in accordance with present invention.

FIG. 6 schematically represents a radial orthographic view of a tread for use with another configuration of the stud in accordance with present invention of FIG. 1.

FIG. 7 schematically represents a general illustration of a tread for use with still another configuration of the studs.

### DETAILED DESCRIPTION OF EXAMPLES OF THE PRESENT INVENTION

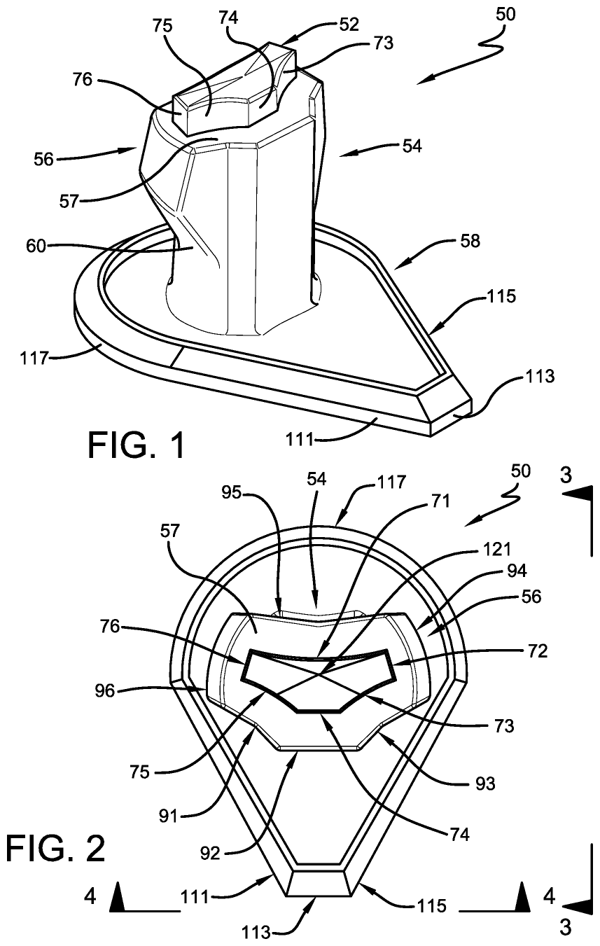

The following is an explanation of a pneumatic or non-pneumatic tire assembly according to the present invention. The assembly may be similar to the pneumatic tire configuration disclosed in U.S. Pat. No. 10,035,382, herein incorporated by reference in its entirety. FIG. 1 of U.S. Pat. No. 10,035,382 schematically represents a tire cross-sectional view illustrating a cross-section of a pneumatic tire. The pneumatic tire may be a tire with studs embedded in a tread portion of the pneumatic tire.

The tire circumferential direction explained hereafter refers to the rotation direction (both rolling directions) of a tread surface of a studded tire 10 about a tire rotation axis. The radial direction of the tire refers a direction radiating about a direction extending orthogonally to/from the tire rotation axis. The outer side in the radial direction of the studded tire 10 may refer to the side away from the tire rotation axis in the radial direction of the studded tire. The tire width direction may be a direction parallel to the tire rotational axis, and the outer side in the tire width direction may refer to two sides away from a tire center line of the studded tire 10.

A studded tire 10 in accordance with the present invention may include a carcass ply layer, a belt layer, and bead cores, which serve as a frame for the studded tire. The studded tire 10 may further include a tread member 18, sidewall members, bead filler members, rim cushion members, and an innerliner member, around the frame for the studded tire.

The carcass ply layer may be formed in a toroidal shape wound between a pair of circular ring-shaped bead cores, and may include rubber coated organic fiber carcass ply members. The carcass ply layer may be configured from multiple carcass ply members or a single carcass ply member. The belt layer may be provided on the outer side in the tire radial direction of the carcass ply layer, configured from two belt members. The belt layer may be constructed of rubber-coated steel cords arranged at a predetermined angle, such as 20 to 30 degrees, relative to the tire circumferential direction. The inclination direction of the steel cords of the two layers of the belt members may be opposite each other.

The tread member 18 may be disposed on an outer side in the tire radial direction of the belt layer. The sidewall members may be connected to two sides of the tread member 18 to form two sidewalls. The tread member 18 may configured from two layers of rubber, an upper tread member disposed on an outer side in the tire radial direction and a lower tread member disposed on an inner side in the tire radial direction. The rim cushion members may be disposed at inner sides in the tire radial direction of the sidewall members and come into contact with a rim on which the studded tire 10 may be fitted. A bead filler material may be disposed between a portion of the carcass ply layer before the carcass ply layer is wound around the bead cores and a portion of the carcass ply layer. The innerliner member may be disposed on an inner surface of the studded tire 10 adjacent a tire cavity region that is filled gas enclosed by the studded tire and the rim. The studded tire 10 may have this tire structure or any other suitable structure, pneumatic and/or non-pneumatic.

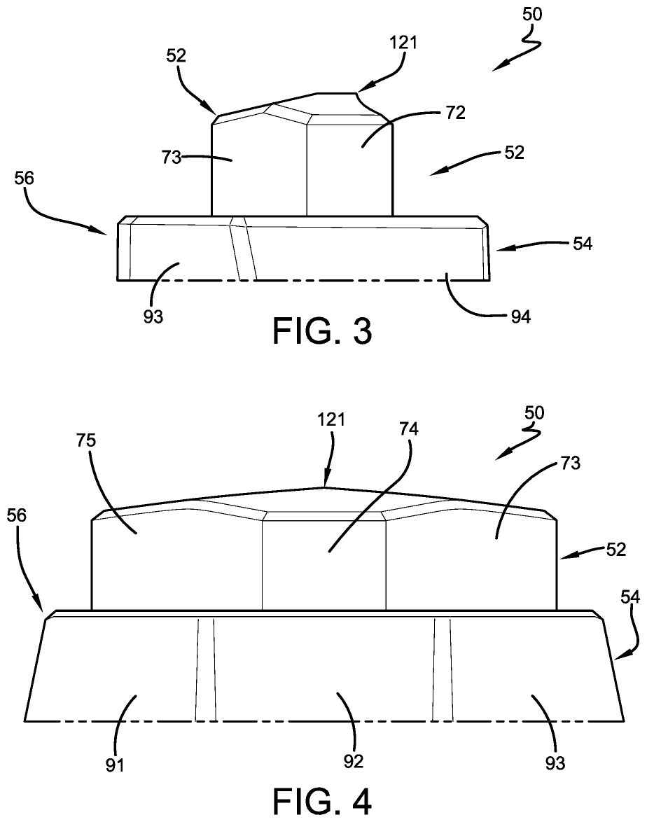

FIG. 1 shows an external perspective view of a stud 50 in accordance with the present invention. FIG. 2 shows a radially inward view of the stud 50 of FIG. 1. FIGS. 3-4 show side views of the stud 50 of FIGS. 1-2. The stud 50 may include a radially outer tip end 52 and a base 54 for partially inserting into corresponding recesses in the tread member 18. The base 54 may thus be partially embedded inside a stud pin installation hole in the tread portion 18 of the tire 10 in which it is installed. The stud 50 may be secured to the tire 10 by side surfaces of the stud pin installation hole pressing and clamping onto part of the base 54.

The base 54 may include a stump portion 56, a bottom portion 58, and a shank portion 60 radially interconnecting the bottom portion and the stump portion. The bottom portion 58 may be located at the radially opposite end of the stump portion 56 and the tip end 52. The stud 50 may thus be formed from the bottom portion 58, the shank portion 60, and the stump portion 56 in that radial ascending order.

As illustrated in FIGS. 1-4, when the stud 50 is installed in the tread portion 18, the tip end 52 is the portion of the stud 50 that may protrude radially from the tread surface, contact the road surface, and claw into ice and/or snow. The tip end 52 may have a hexagonal-like shape (FIG. 2) extending radially outward from a radially outermost surface of the stump portion 56 of the base 54. The cross-section of the tip end 52 may include three concave curved hollows 71, 73, 75 with three planar sides 72, 74, 76. That is, the outer peripheral surface of the tip end 52 may comprise three cavities 71, 73, 75 and three flat sides 72, 74, 75 (FIG. 2). Other suitable numbers of cavities and sides may be configured for the tip end 52.

The stump portion 56 may be a flange located between the tip end 52 and the shank portion 60. In other words, the tip end 52 may be formed radially extending outward from the flat radially outer surface 57 of the stump portion 56. When this stud 50 is installed in the tire 10, the stump portion 56 may be embedded inside the tread member 18. The shape of the stump portion 56 may be similarly shaped to the tip end 52 with a flat side 92 circumferentially between two concave hollows 91, 93 and two convex sides 94, 96 circumferentially separated by a third concave hollow 95. The outer peripheral surface 91, 92, 93, 94, 95, 96 of the stump portion 56 may contact and press against the inside surface of the installation holes of the tread member 18, as is conventionally known. The cross-section of the stump portion 56 may alternatively be substantially triangular, quadrilateral, pentagonal, hexagonal (FIG. 2), or other polygonal shape.

The bottom portion 58 may be a flange located opposite the tip end 52. The cross-section of the bottom portion 58 may be substantially a tear-drop shape with three planar sides 111, 113, 115 and one semicircular side 117 (FIG. 2). The cross-section of the bottom portion 58 may alternatively be a substantially triangular, quadrangular, pentagonal, or hexagonal shape. Thus, the tip end 52, stump portion 56, and bottom portion 58 each form a generally arrowhead shape with each of the arrowheads pointing in the same direction (downward in FIG. 2).

Generally, the bottom portion 58 may be inserted into a corresponding similarly tear-drop shaped stud pin installation hole in the tread member 18 of the tire 10 thereby securing the orientation of the stud 50 and preventing rotation of the stud during use. Alternatively, the stud pin installation hole may be circular or other suitable shape allowing the bottom portion 58 to be secured against rotation.

The shank portion 60 may connect the stump portion 56 and the bottom portion 58. The shank portion 60 may have a smaller, or thinner, cross-section compared to the trunk portion 56 and the bottom portion 58. The cross-section of the shank portion 60 may be generally oval-shaped (FIG. 1).

The radially outermost surface of the tip end 52 may have four generally planar surfaces forming an outer point 121 for improving engagement of the stud 50 with an ice surface (FIGS. 1 & 3). The tip end 52 and the base 54 may be constructed of same metallic material or from different metallic materials. For example, the tip end 52 and the base 54 may be made from aluminum. The tip end 52 may be made from tungsten carbide and the base 54 may be made from aluminum. If the tip end 52 and the base 54 are made from different metallic materials, the tip end 52 may be fixed to the base 54 by pushing and interference fitting a projection (not shown) of the tip end 52 into a hole (not shown) of the stump portion 56 of the base 54.

If the side surface of the stud installation hole is in contact with the semicircular side 117 of the bottom portion 58 when the stud 50 enters a cylindrical stud pin installation hole in the tire 10, the planar side 113 opposite the semicircular side 117 of the bottom portion 58 may dig into the opposite side surface of the cylindrical stud pin installation hole of the tread member 18 thereby inhibiting the bottom portion 58, and the entire stud 50, from rotating during use. Generally, no matter the shape of the stud installation hole, the rubber of the tread member 18 may conform to the shape and various surfaces of the stud 50 to secure the stud to the tread member.

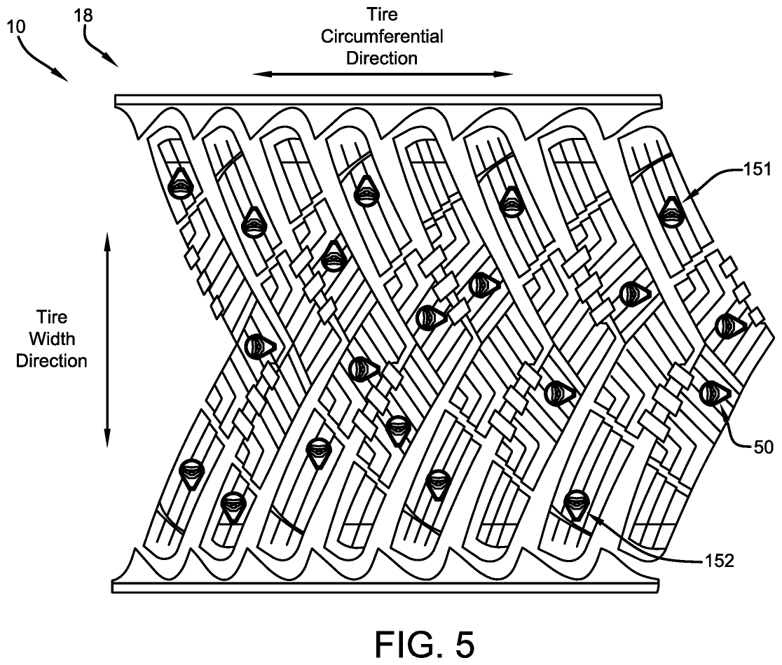

FIG. 5 shows a schematic plan view of a portion of a tread pattern for use with the stud 50. The tire 10 may have a designated rotational direction indicating a tire circumferential direction. The tread pattern may include circumferential main grooves, first angled grooves, second angled grooves, and third angle grooves (FIG. 5). The grooves may have an exemplary depth of 8.5 mm to 10.5 mm and a maximum width of 12.0 mm. The tread pattern illustrated in FIG. 5 is merely one example tread pattern. Other suitable tread patterns may also be used with stud 50. As shown in FIG. 5, some of the studs 50 may have a first orientation and other identical studs 151, 152 may have a second orientation rotated 90 degrees or −90 degrees from the first orientation.

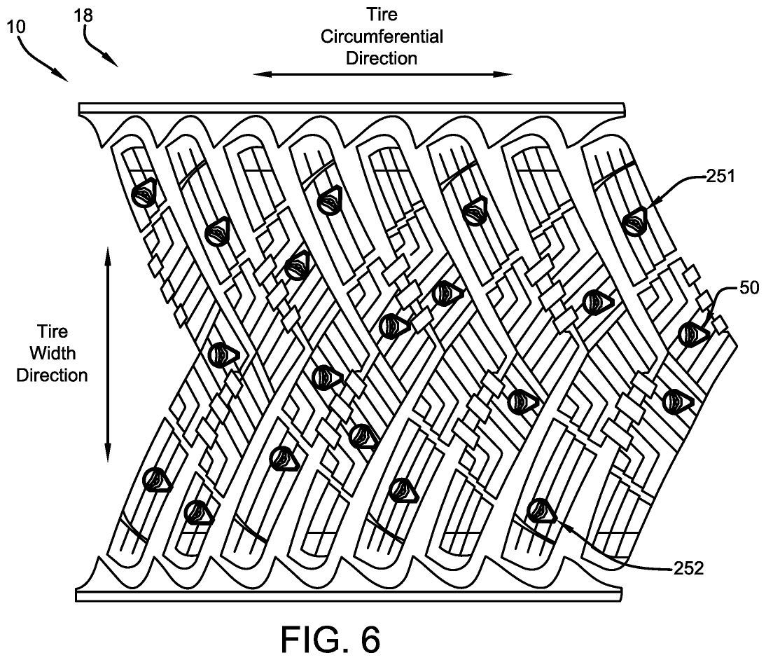

FIG. 6 shows a schematic plan view of a portion of a tread pattern for use with the stud 50. The tire 10 may have a designated rotational direction indicating a tire circumferential direction. The tread pattern may include circumferential main grooves, first angled grooves, second angled grooves, and third angle grooves (FIG. 6). The grooves may have an exemplary depth of 8.5 mm to 10.5 mm and a maximum width 12.0 mm. The tread pattern illustrated in FIG. 6 is merely one example tread pattern. Other suitable tread patterns may also be used with stud 50. As shown in FIG. 6, some of the studs 50 may have a first orientation and other identical studs 251, 252 may have a second orientation rotated 45 degrees or −45 degrees from the first orientation.

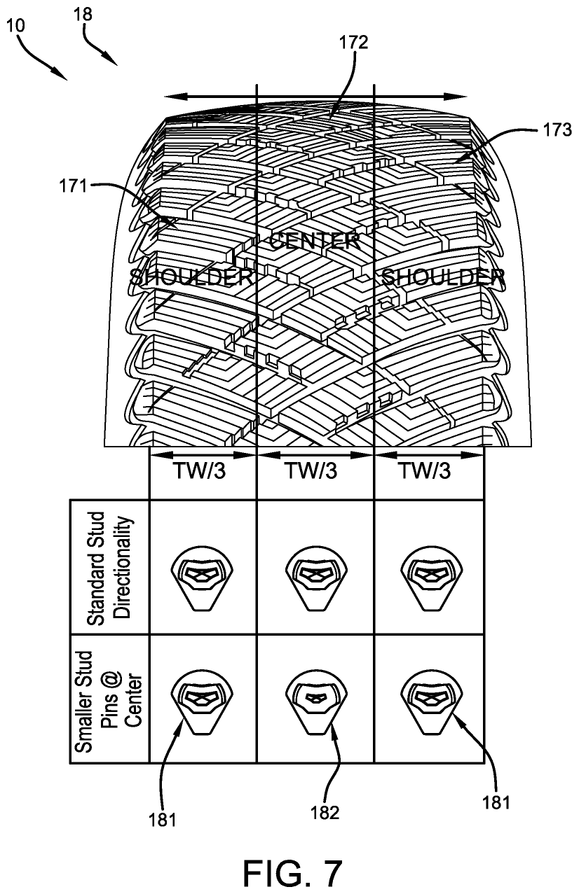

As shown in FIG. 7, tread contact pressure (tire tread contact with pavement or icy roads) may be higher at the tread shoulders 171, 173 than the tread center 172. Thus, in accordance with the present invention, the tip ends of the studs 181 in the tread shoulders 171, 173 may be larger than the tip ends of the studs 182 in the tread center 172 to compensate for lower contact pressure in the tread center. Since the effectiveness of the studs 181, 182 may depend on ice hardness and the capability of the tip end of the stud pin to penetrate the ice, larger tip ends may perform better than smaller tip ends in “warmer”, relatively soft ice, such as −2° C. to −5° C. Conversely, smaller tip ends may perform better than larger tip ends in “colder”, relatively hard ice, such as −20° C. to −30° C. Dual stud types/sizes of studs and tip ends in a single tread may thereby perform well in both of the soft ice and hard ice circumstances described above.

The tip ends of the studs of the tires and configurations of such tip ends according to the present invention have been described above in exemplary detail. However, a tire, a stud, and/or configuration according to the present invention may not be limited to the above examples and may be modified and given various substitutions in accordance with the spirit and the scope of the present invention.

What is claimed:

1. A stud configured to be inserted into a tread portion of a tire, the stud comprising:
a tip end protruding from the tread portion for contacting a surface; and
a base including a flanged bottom portion provided on an end opposite the tip end and extending radially outward, a stump portion provided between the bottom portion and the tip end, and a shank portion interconnecting the stump portion and the bottom portion,
the base being embedded and secured in the tread portion of the tire in which the stud is installed, the bottom portion having a tear-drop shape consisting of three planar sides and one semi-cylindrical side, the stump portion having a polygonal shape consisting of three concave sides, two convex sides, and one planar side.

2. The stud as set forth in claim 1 wherein the tip end has a hexagonal-like cross-sectional shape extending radially outward from a radially outermost surface of the stump portion of the base.

3. The stud as set forth in claim 1 wherein the tip end has a cross-section with three concave surfaces with three planar surfaces.

4. The stud as set forth in claim 1 wherein the cross-section of the stump portion includes a flat side circumferentially disposed between first and second concave hollows and two convex sides circumferentially separated by a third concave hollow.

5. The stud as set forth in claim 1 wherein the cross-section of the stump portion includes a flat side circumferentially disposed between first and second concave hollows and first and second convex sides circumferentially separated by a third concave hollow, the first concave hollow being adjacent the first convex side and the second concave hollow being adjacent the second convex side.

6. The stud as set forth in claim 1 wherein the bottom portion has a tear drop cross-section with three planar sides and one semi-cylindrical side.

7. The stud as set forth in claim 1 wherein the shank portion has a thinner cross-section compared to the bottom portion.

8. The stud as set forth in claim 1 wherein the shank portion has a thinner cross-section compared to the trunk portion.

9. The stud as set forth in claim 1 wherein the shank portion has an oval-shaped cross-section.

10. The stud as set forth in claim 1 wherein the tip end has a radially outermost surface with four generally planar surfaces converging to form an outer point for improving engagement of the stud with an ice surface.

11. A stud configuration for a tire tread comprising:
a first plurality of studs disposed in a first region of the tire tread, the first plurality of studs each having a first orientation;
a second plurality of studs disposed in a second region of the tire tread, the second plurality of studs each having a second orientation rotated +90 degrees relative to a radial axis; and
a third plurality of studs disposed in a third region of the tire tread, the third plurality of studs each having a third orientation rotated −90 degrees relative to the radial axis.

12. The stud configuration as set forth in claim 11 wherein the first plurality of studs, the second plurality of studs, and the third plurality of studs each have an identical construction.

13. The stud configuration as set forth in claim 11 wherein the first region is a shoulder portion of the tread portion, the second region is a center portion of the tread portion, and the third region is another shoulder portion of the tread portion.

14. The stud configuration as set forth in claim 11 wherein the first plurality of studs each have a tip end with a first size, the second plurality of studs each have a tip end with a second size, and the third plurality of studs each have a tip end with the first size, the first size being larger than the second size.

15. The stud configuration as set forth in claim 11 wherein the first plurality of studs each have a tip end with a first size, the second plurality of studs each have a tip end with a second size, and the third plurality of studs each have a tip end with the first size, the second size being larger than the first size.

16. A stud configuration for a tire tread comprising:
a first plurality of studs disposed in a first region of the tire tread, the first plurality of studs each having a first orientation;
a second plurality of studs disposed in a second region of the tire tread, the second plurality of studs each having a second orientation rotated +45 degrees relative to a radial axis; and
a third plurality of studs disposed in a third region of the tire tread, the third plurality of studs each having a third orientation rotated −45 degrees relative to the radial axis.

17. The stud configuration as set forth in claim 16 wherein the first plurality of studs, the second plurality of studs, and the third plurality of studs each have an identical construction.

18. The stud configuration as set forth in claim 16 wherein the first region is a shoulder portion of the tread portion, the second region is a center portion of the tread portion, and the third region is another shoulder portion of the tread portion.

19. The stud configuration as set forth in claim 16 wherein the first plurality of studs each have a tip end with a first size, the second plurality of studs each have a tip end with a second size, and the third plurality of studs each have a tip end with the first size, the first size being larger than the second size.

20. The stud configuration as set forth in claim 16 wherein the first plurality of studs each have a tip end with a first size, the second plurality of studs each have a tip end with a second size, and the third plurality of studs each have a tip end with the first size, the second size being larger than the first size.
